(19) United States
(12) Patent Application Publication
(10) Pub. No.: US 2009/0009114 A1
(43) Pub. Date: Jan. 8, 2009

(54) SYNCHRONOUS MACHINE

(75) Inventors: Holger Schunk, Lendershausen (DE); Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 11/994,466

(22) PCT Filed: Jun. 28, 2006
(86) PCT No.: PCT/EP06/63649

§ 371 Date: Sep. 22, 2008

(30) Foreign Application Priority Data
Jul. 1, 2005 (DE) 10 2005 030 826.0

(51) Int. Cl. H02P 6/18; H02K 1/06

(52) U.S. Cl. 318/400.32; 310/179

(57) ABSTRACT

The invention relates to a synchronous machine provided with a stator and rotor, wherein the stator comprises stator teeth (1) provided with respective tooth tips in the bore hole thereof and tooth coils guided around the stator teeth (1), the rotor core discs (2) and a shaft are arranged and permanent magnet poles are formed on the external side of the rotor by means of permanent magnets (4), a pole gap (3) is provided in the rotation direction of the rotor between two magnetic poles, respectively, and is filled with a magnetically conductive material, the stator teeth (1) angle is equal to or less than 85% of a pole pitch angle or the stator teeth (1) angle is equal to or greater than 115% of the pole pitch angle.

The invention relates to a synchronous machine having a stator and a rotor, with the stator having stator teeth, each with a tooth head, in the stator bore, and with tooth-wound coils being passed around the stator teeth, with the rotor containing rotor laminates and a shaft, and with magnetic poles being formed by means of permanent magnets on the outside of the rotor.

Electrical machines are used in a very wide range of technical fields. A distinction should be drawn in the case of electrical machines between direct-current machines, alternating-current machines and three-phase machines. Three-phase machines can be subdivided into three-phase synchronous machines and three-phase asynchronous machines.

All of these electrical machines contain, inter alia, a stationary stator and a rotor which is mounted such that it can rotate. The rotor and/or the stator are/is fitted with a winding system, depending on the design. This winding system may be composed of one or more wire windings or bar windings.

In the case of synchronous machines, it is known that information is required about the respective rotor position in order to control the movement process. This information is normally obtained from a rotation-angle sensor. One possible synchronous motor is disclosed in German Laid-Open Specification DE 103 26 167 A1.

However, this has the disadvantage that the synchronous motor disclosed in German Laid-Open Specification DE 103 26 167 A1 is not very suitable for determining the rotation angle without the use of a sensor or sensors.

The invention is therefore based on the object of specifying a synchronous motor in which the rotation angle can be determined without any further rotation-angle sensor.

According to the invention, this object is achieved in that: in each case one pole gap is provided between in each case two magnetic poles in the rotation direction of the rotor and is filled with magnetically permeable material, the angle of the stator tooth is less than or equal to 85% of the pole pitch angle, or the angle of the stator tooth is greater than or equal to 115% of the pole pitch angle.

This advantageously means that a varying inductance profile is produced in the synchronous machine when the rotor is rotating. Furthermore, just the choice of the described ratio of the angle of the stator tooth with respect to the pole pitch angle maximizes or increases the difference between the maximum inductance and the minimum inductance such that the rotation angle of the synchronous machine can be determined very accurately. Because of the measurement inaccuracies and disturbances that occur, this makes it easier to measure the difference. Each magnetic pole may be formed from one or more permanent magnets.

In a further advantageous refinement, the pole gaps between magnetic poles that are located alongside one another are filled with magnetically permeable material such that no steps occur at the transition points between the filled pole gaps and the permanent magnets.

This advantageously ensures that the permanent magnets are optimally fixed on the rotor. Furthermore, the permanent magnets are therefore well protected against mechanical influences before the rotor is installed in the stator.

The permanent magnets are advantageously adhesively bonded to the rotor. This speeds up the manufacturing process for the rotor.

Alternatively or else additionally, the permanent magnets can be held on the rotor by means of tabs or webs which are connected to the rotor, with the tabs or webs touching the permanent magnets at least on the radially outer face. The webs can also be designed such that they entirely cover the permanent magnets, so that the permanent magnets are located in cavities or pockets.

This advantageously means that the permanent magnets are held securely on the rotor even at high rotation speeds and with high centrifugal forces. Furthermore, this provides mechanical protection for the permanent magnets.

A further optimization of the manufacturing process for the rotor is obtained by the rotor laminates having teeth which at least partially fill the pole gaps between the permanent magnets of magnetic poles which are located alongside one another. This results in the pole gaps being filled even during the process of production of the rotor laminates.

For optimum operation of the synchronous motor, the permanent magnets which are attached to the rotor are polarized in the radial direction, with in each case two magnetic poles which are located alongside one another in the rotation direction of the rotor having different polarization directions.

Furthermore, the synchronous motor has an associated measurement device for measurement of the rotation-angle-dependent inductance. This advantageously defines a signal which is equivalent to the rotation angle. Alternatively, it is also feasible for the measurement device to additionally also determine the rotation angle from the inductance.

The synchronous motor has at least one associated converter which supplies current to the synchronous motor. Furthermore, the synchronous motor has an associated control device which evaluates the measured inductance and/or the rotation angle and drives the converter.

The invention as well as further advantageous refinements of the invention according to the features of the dependent claims will be explained in more detail in the following text with reference to exemplary embodiments which are schematically illustrated in the drawing, without this resulting in any restriction of the invention to this exemplary embodiment. In the figures:

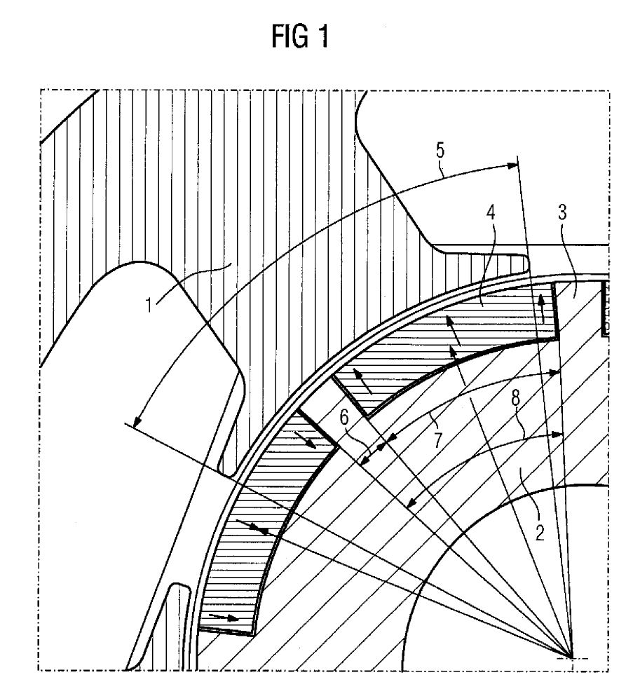

FIG. 1 shows a part of a synchronous machine according to the invention; and

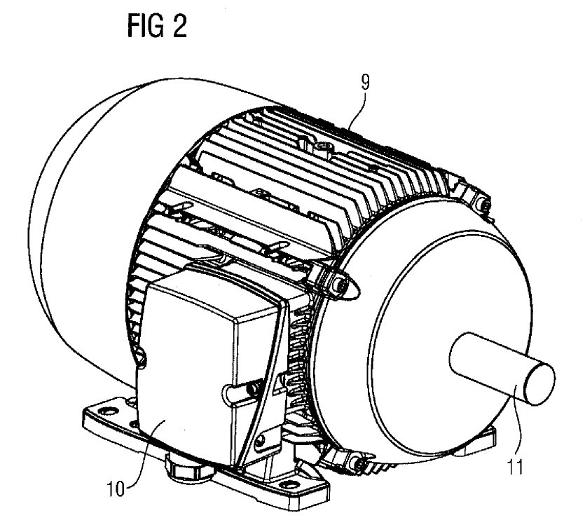

FIG. 2 shows a synchronous machine according to the invention.

FIG. 1 shows a part of a synchronous machine according to the invention. In this case, the stator laminate is shown with one stator tooth 1. Furthermore, the figure shows the rotor laminate 2, which projects into the pole gap 3. In this exemplary embodiment, the permanent magnets 4 are therefore gripped, and therefore securely held, by the rotor laminate projecting into the pole gap 3. Furthermore, the angle 5 of the stator tooth 1 as well as the angle δ of the pole gap 3, the angle 7 of a permanent magnet 4 and the pole pitch angle 8 are specified. In FIG. 1, each permanent magnet therefore forms one magnetic pole.

In the illustrated exemplary embodiment, the angle 5 of the stator tooth 1 is greater than 115% of the pole pitch angle 8. This advantageously means that a varying inductance profile is produced in the synchronous machine when the rotor is rotated. Furthermore, just the choice of the described ratio of the angle of the stator tooth with respect to the pole pitch angle maximizes or increases the difference between the maximum inductance and the minimum inductance such that the rotation angle of the synchronous machine can be determined very accurately. Because of the measurement inaccuracies and disturbances that occur, this makes it easier to measure the difference.

This means that the width of a stator tooth 1 should differ by at least 15% from the pole pitch angle 8 in order to ensure precise measurement of the rotation angle. The synchronous motor according to the invention now makes it possible to save a rotation angle sensor, since the instantaneous rotation angle can be determined from the rotation-angle-dependent inductance of the synchronous machine. A converter can now be driven with the aid of the rotation angle signal by means of a control device, in order to optimally supply current to the synchronous motor. The position-dependent inductance of the synchronous motor is in this case measured by a suitable measurement apparatus, and is used by the control device in order to drive the converter.

FIG. 2 shows a synchronous machine according to the invention with the shaft 11 and the housing 9. The synchronous machine can be connected to an electrical power source via the switchbox 10.

1-9. (canceled)

10. A synchronous machine, comprising:
a stator having a stator bore, stator teeth, each stator tooth having a tooth head in the stator bore, and tooth-wound coils being passed around the stator teeth, wherein an angle between the stator teeth is less than or equal to 85% of a pole pitch angle, or the angle between the stator teeth is greater than or equal to 115% of the pole pitch angle;
a rotor including rotor laminates and a shaft, wherein magnetic poles are formed by permanent magnets arranged on an outside of the rotor, and wherein the rotor is constructed to have a pole gap which is provided between two magnetic poles in a rotation direction of the rotor and filled with magnetically permeable material; and
a measurement device for measurement of a rotation-angle-dependent inductance.

11. The synchronous machine of claim 10, wherein the pole gap between magnetic poles that are located alongside one another are filled with magnetically permeable material such that no steps occur at transition points between the filled pole gaps and the permanent magnets.

12. The synchronous machine of claim 10, wherein the permanent magnets are adhesively bonded to the rotor.

13. The synchronous machine of claim 10, wherein the permanent magnets are held on the rotor by tabs or webs which are connected to the rotor, with the tabs or webs touching the permanent magnets at least on a radially outer face.

14. The synchronous machine of claim 10, wherein the rotor laminates have teeth which at least partially fill the pole gaps between the permanent magnets of neighboring magnetic poles.

15. The synchronous machine of claim 10, wherein the permanent magnets are attached to the rotor and polarized in a radial direction, with two magnetic poles which are located alongside one another in the rotation direction of the rotor having different polarization directions.

16. The synchronous machine of claim 10, further comprising at least one converter for supply of current.

17. The synchronous machine of claim 16, further comprising a control device to evaluate a measured inductance and to operate the converter in response to the measured inductance.
